(19) United States
(12) Patent Application Publication
(10) Pub. No.: US 2013/0242187 A1
(43) Pub. Date: Sep. 19, 2013

(54) DISPLAY DEVICE, DISPLAY CONTROL METHOD, CELLULAR PHONE, AND SEMICONDUCTOR DEVICE

(71) Applicant: PANASONIC CORPORATION, Osaka (JP)

(72) Inventors: Akio NODA, Kanagawa (JP); Takaharu MOROHASHI, Osaka (JP); Kazuyuki UCHIDA, Osaka (JP)

(73) Assignee: PANASONIC CORPORATION, Osaka (JP)

(21) Appl. No.: 13/891,915

(22) Filed: May 10, 2013

Related U.S. Application Data
(63) Continuation of application No. PCT/JP2011/004241, filed on Jul. 27, 2011.

(30) Foreign Application Priority Data
Nov. 17, 2010 (JP) 2010-257196

(51) Int. Cl. H04N 5/63; H04N 7/01

(52) U.S. Cl. CPC H04N 5/63; H04N 7/0127
USPC 348/441

(57) ABSTRACT

A display device decides a face detection situation. When the face detection situation is in the range from the absence of face detection, in which a face facing an LCD display screen is not detected, to detection of one-half of the face, a display rate is set at a low rate by a display rate determining unit. When the face detection situation is in the range from detection of one-half of the face to detection of three-fourths of the face, the display rate is set at a medium rate by the display rate determining unit. When the face detection situation is in the range from detection of three-fourths of the face to detection of all of the face, the display rate is set at a normal rate by the display rate determining unit.

### BACKGROUND OF THE INVENTION

1. Field of the Invention

The present invention relates to a display device for changing a display rate and displaying an image, a display control method, a cellular phone and a semiconductor device.

2. Description of the Related Art

In recent years, the size of an angle of view of a moving image capable of viewing or reproduction is increasing in a mobile terminal such as a cellular phone or a smart-phone. For example, in digital TV for the mobile terminal providing service in the name of “One Seg” at present, moving image broadcasting having the size of an angle of view of QVGA (320×240) can be viewed in most of the mobile terminals. Also, in Internet moving images of YouTube (registered trademark) etc., the size of an angle of view capable of being handled by the mobile terminal is about VGA (640×360) in the present circumstances, but it is expected that handling is enabled to Full HD (1920×1080) in future. Also, with respect to Full HD (1920×1080) which is the size of an angle of view of digital TV, it is expected to be able to be handled by the mobile terminal.

On the other hand, display resolution of an LCD etc. in the present mobile terminal is about QHD (960×540) at a maximum. However, as described above, it is expected that the size of an angle of view capable of being handled in a moving image in the mobile terminal increases in future. As the size of the angle of view increases, the display resolution also increases gradually, and it is expected to reach Full HD (1920×1080) in the near future. However, when the display resolution also increases as the size of the angle of view capable of being handled in the moving image increases, power consumption increases. Particularly, it is important to achieve a saving in electric power by reducing an increase in power consumption in the mobile terminal. As a method for achieving a saving in electric power, the art of converting a frame rate is described in JP-A-2007-318193.

### SUMMARY OF THE INVENTION

In the art described in JP-A-2007-318193, the frame rate is converted based on information about an image signal of a program genre etc. or movement of an image. By controlling the frame rate according to image information or moving image information thus, the saving in electric power is achieved. However, consideration is not given to a situation of a viewer, so that the viewer may have a feeling of strangeness and also, efficiency of the saving in electric power is not good. Also, in the case of conversion of the frame rate, only image information is used, so that a caption signal or a sound signal in synchronization with an image is not utilized and the efficiency of the saving in electric power is not good.

An object of the present invention is to provide a display device capable of decreasing a display rate according to a situation of a viewer or using information other than image information and efficiently achieving a saving in electric power without giving a feeling of strangeness to the viewer, a display control method, a cellular phone and a semiconductor device.

The present invention provides a display device configured to display an image, including an image storage unit configured to store an image signal inputted at a predetermined frame rate, a detecting unit configured to detect data used in a case of deciding a situation of a viewer, a viewer situation deciding unit configured to decide the situation of the viewer from the data detected by the detecting unit, a display rate determining unit configured to determine a display rate based on the situation of the viewer decided by the viewer situation deciding unit and the predetermined frame rate at which the image signal is inputted, and a display unit configured to read out image data stored in the image storage unit and display an image at the display rate determined by the display rate determining unit.

According to the present invention, the display rate is determined based on the situation of the viewer and the predetermined frame rate at which the image signal is inputted, so that the display rate can be decreased according to the situation of the viewer and a saving in electric power can efficiently be achieved without giving a feeling of strangeness to the viewer.

In the display device described above, the detecting unit includes an imaging unit configured to image the front of the display unit.

Consequently, the situation of the viewer can be decided from an image imaged by the imaging unit.

In the display device described above, the viewer situation deciding unit decides whether or not a face of a viewer is present in an image imaged by the imaging unit.

Consequently, it can be estimated whether or not the viewer has gazed.

In the display device described above, the display rate determining unit determines the display rate so as to become lower than the predetermined frame rate when the viewer situation deciding unit decides that a face of a viewer is not present.

Consequently, in the case of estimating that the viewer has not gazed, the display rate decreases to lead to a saving in electric power.

In the display device described above, the display rate determining unit determines the display rate according to expression of the face when the viewer situation deciding unit decides that the face of a viewer is present.

Consequently, the situation of the viewer can be decided more finely.

In the display device described above, the display rate is determined so as to become lower than the predetermined frame rate when the viewer situation deciding unit decides that the viewer is laughing, sleeping or crying.

Consequently, in the case of estimating that the viewer has not seen the display device carefully, the display rate can be decreased.

In the display device described above, the detecting unit includes a sensor for detecting a state of the display device.

Consequently, the situation of the viewer can be decided from the state of the display device detected by the sensor.

In the display device described above, the sensor includes a distance sensor for detecting a distance to an object facing the front of the display unit.

Consequently, the state of the display device can be detected from the distance to the object present in the front.

In the display device described above, the viewer situation deciding unit decides whether or not a distance detected by the distance sensor is within a certain range.

Consequently, it can be decided whether or not the distance is a distance estimated that the viewer has gazed.

In the display device described above, the display rate determining unit determines the display rate so as to become lower than the predetermined frame rate when a distance detected by the distance sensor is not within a certain range.

Consequently, when the distance is not within the certain range, it is estimated that the viewer has not gazed, and the display rate can be decreased and an efficient saving in electric power can be achieved.

In the display device described above, the sensor is a directional sensor for detecting left, right, upward and downward directions and front and back directions as an attitude of the display device.

Consequently, the attitude of the display device is grasped.

In the display device described above, the viewer situation deciding unit decides whether or not an upward direction and a front direction are detected by the directional sensor.

Consequently, it can be decided whether or not the attitude is the attitude of the display device estimated that the viewer has gazed.

In the display device described above, the display rate determining unit determines the display rate so as to become lower than the predetermined frame rate when the viewer situation deciding unit decides that directions other than an upward direction and a front direction are detected.

In the case of no attitude estimated that the viewer has gazed, the display rate decreases, so that an efficient saving in electric power can be achieved.

In the display device described above, the sensor includes a motion sensor for detecting motion of the display device.

Consequently, the motion of the display device can be detected.

In the display device described above, the viewer situation deciding unit decides whether or not motion of the display device is a predetermined value or more by the motion sensor.

Consequently, it can be decided whether or not the motion is the motion of the display device estimated that the viewer has gazed.

In the display device described above, the display rate determining unit determines the display rate so as to become lower than the predetermined frame rate when the viewer situation deciding unit decides that motion of the display device is a predetermined value or more.

When the motion of the display device is large, the display rate decreases, so that an efficient saving in electric power can be achieved.

The display device described above includes an image processing unit for performing image processing with respect to image data displayed at a display rate determined by the display rate determining unit.

Consequently, the image processing can be performed regardless of a change in the display rate.

The display device described above includes a frame interpolating unit for executing frame interpolation with respect to image data displayed at a display rate determined by the display rate determining unit.

Consequently, the display rate can be doubled.

The present invention provides a display device for displaying an image, including an image storage unit configured to store an image signal inputted at a predetermined frame rate, a synchronous data storage unit configured to store data in synchronization with the image signal, a data analyzing unit configured to analyze the data stored in the synchronous data storage unit, a display rate determining unit configured to determine a display rate based on an analysis result of the data by the data analyzing unit and the predetermined frame rate at which the image signal is inputted, and a display unit configured to read out image data stored in the image storage unit and displaying an image at the display rate determined by the display rate determining unit.

According to the present invention, using information other than image information, the display rate can be changed and a saving in electric power can be achieved without giving a feeling of strangeness to a viewer.

In the display device described above, data stored in the synchronous data storage unit is caption data.

Consequently, using update timing of the caption data in synchronization with a moving image, the display rate can be changed and a saving in electric power can be achieved without giving a feeling of strangeness to the viewer.

In the display device described above, the data analyzing unit analyzes update timing of caption data stored in the synchronous data storage unit.

Consequently, the update timing of the caption data is decided.

In the display device described above, the display rate determining unit determines a display rate according to update timing of caption data analyzed by the data analyzing unit.

Consequently, the display rate is changed according to the update timing of the caption data.

In the display device described above, data stored in the synchronous data storage unit is sound data.

Consequently, the sound data in synchronization with a moving image can be analyzed.

In the display device described above, the data analyzing unit decides an exciting scene from sound data stored in the synchronous data storage unit.

Consequently, the exciting scene can be decided and the display rate can be changed using this decision result.

In the display device described above, the display rate determining unit determines the display rate so as to become lower than the predetermined frame rate when the data analyzing unit does not decide that it is an exciting scene.

Consequently, except the exciting scene, the display rate can be decreased and a saving in electric power can be achieved.

The display device described above includes an image processing unit for performing image processing with respect to image data displayed at a display rate determined by the display rate determining unit.

Consequently, the image processing can be performed regardless of a change in the display rate.

The display device described above includes a frame interpolating unit for executing frame interpolation with respect to image data displayed at a display rate determined by the display rate determining unit.

Consequently, the display rate can be doubled.

The present invention provides a display control method of a display device which includes an image storage unit configured to store an image signal inputted at a predetermined frame rate and displays an image based on the image signal stored in the image storage unit, comprising a detecting step of detecting data used in the case of deciding a situation of a viewer, a viewer situation deciding step of deciding the situation of the viewer from the data detected in the detecting step, a display rate determining step of determining a display rate based on the situation of the viewer decided in the viewer situation deciding step and the predetermined frame rate at which the image signal is inputted, and a display step of reading out image data stored in the image storage unit and displaying an image at the display rate determined in the display rate determining step.

According to the present invention, the display rate can be decreased according to the situation of the viewer and a saving in electric power can efficiently be achieved without giving a feeling of strangeness to the viewer.

The present invention provides a display control method of a display device which includes an image storage unit for storing an image signal inputted at a predetermined frame rate and displays an image based on the image signal stored in the image storage unit, having a data analyzing step of analyzing data stored in a synchronous data storage unit, a display rate determining step of determining a display rate based on an analysis result of the data in the data analyzing step and the predetermined frame rate at which the image signal is inputted, and a display step of reading out image data stored in the image storage unit and displaying an image at the display rate determined in the display rate determining step.

According to the present invention, using information other than image information, the display rate can be changed and a saving in electric power can be achieved without giving a feeling of strangeness to a viewer.

The present invention provides a cellular phone including the display device described above, and a telephone call unit capable of making a telephone call.

Consequently, a further saving in electric power can be achieved by decreasing a display rate in a situation in which power consumption necessary for display processing occupies one-half or more of the power consumption of a portable terminal and display resolution of the portable terminal is further increasing in future.

The present invention provides a semiconductor device mounted in a display device, including a viewer situation deciding unit for deciding a situation of a viewer from data detected by a sensor, and a display rate determining unit for determining a display rate in the case of displaying an image based on an image signal based on the situation of the viewer decided by the viewer situation deciding unit and a predetermined frame rate at which the image signal is inputted.

Consequently, incorporation into various display devices is enabled.

The present invention provides a semiconductor device mounted in a display device, including a data analyzing unit configured to analyze data in synchronization with an image signal, and a display rate determining unit configured to determine a display rate in the case of displaying an image based on the image signal based on an analysis result of the data by the data analyzing unit and a predetermined frame rate at which the image signal is inputted.

Consequently, incorporation into various display devices is enabled.

According to the present invention, the display rate is determined based on the situation of the viewer and the predetermined frame rate at which the image signal is inputted, so that the display rate can be decreased according to the situation of the viewer and a saving in electric power can efficiently be achieved without giving a feeling of strangeness to the viewer. Also, using information other than image information, the display rate can be changed and a saving in electric power can be achieved without giving a feeling of strangeness to the viewer.

### BRIEF DESCRIPTION OF THE DRAWINGS

FIG. 1 is a diagram showing a configuration of a display device 100 of a first embodiment.

FIGS. 2(A) and 2(B) are diagrams showing an external appearance of the display device 100.

FIG. 3 is a graph showing a change in a display rate corresponding to a face detection situation.

FIG. 4 is a flowchart showing a display operation procedure of the display device 100.

FIGS. 5(A) to 5(C) are diagrams showing facial expressions capable of being detected by a viewer situation deciding unit 102.

FIG. 6 is a graph showing a change in a display rate corresponding to a facial expression detection situation.

FIGS. 7(A) and 7(B) are diagrams showing an external appearance of a display device provided with an infrared sensor as a viewer sensor.

FIG. 8 is a graph showing a change in a display rate corresponding to a situation of a distance.

FIG. 9 is a diagram showing a configuration of a display device 300 of a second embodiment.

FIG. 10 is a diagram showing frames instructed to display image data.

FIG. 11 is a flowchart showing a display operation procedure of the display device 300.

FIG. 12 is a diagram showing a configuration of a display device 400 of a third embodiment.

FIG. 13 is a graph showing a change in a display rate corresponding to a sound data analysis result.

FIG. 14 is a flowchart showing a display operation procedure of the display device 400.

FIG. 15 is a diagram showing a configuration of a cellular phone 500 in which a display device of a fourth embodiment is mounted.

FIG. 16 is a diagram showing a configuration of a cellular phone 600 in which a display device of a fifth embodiment is mounted.

FIG. 17 is a diagram showing a configuration of a semiconductor chip 700 of a sixth embodiment.

FIG. 18 is a diagram showing a configuration of a semiconductor chip 800 of a seventh embodiment.

### DESCRIPTION OF THE PREFERRED EMBODIMENTS

Embodiments of a display device, a display control method, a cellular phone and a semiconductor device according to the present invention will hereinafter be described with reference to the drawings. The display device of the embodiment described below is mounted in electronic equipment such as a mobile portable terminal.

### First Embodiment

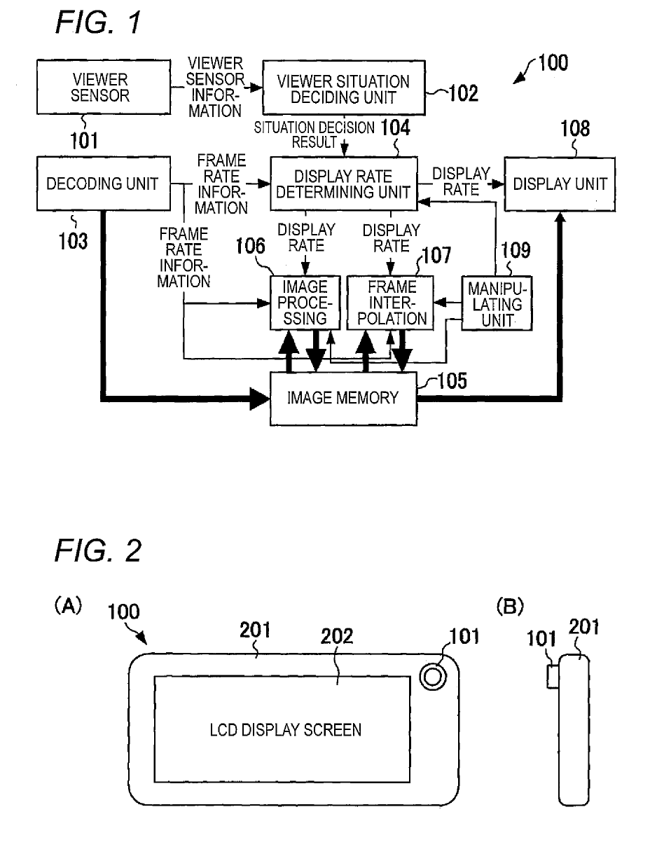

FIG. 1 is a diagram showing a configuration of a display device 100 of a first embodiment. FIGS. 2(A) and 2(B) are diagrams showing an external appearance of the display device, and FIG. 2(A) shows the front of the display device and FIG. 2(B) shows the side of the display device.

The display device 100 of the first embodiment has a viewer sensor 101, a viewer situation deciding unit 102, a decoding unit 103, a display rate determining unit 104, an image memory 105, an image processing unit 106, a frame interpolating unit 107, a display unit 108, and a manipulating unit 109.

The decoding unit 103 decodes (decodes), for example, moving image data of digital TV broadcasting. Also, the decoding unit 103 decodes (decodes) the moving image data at a speed according to the moving image data, and stores image data (image signal) which is this decoding result in the image memory 105 (image storage unit). In the first embodiment, a decoding speed of the moving image data is 60 fps (frame per second). The decoding unit 103 notifies the display rate determining unit 104, the image processing unit 106 and the frame interpolating unit 107 of frame rate information (60 fps) simultaneously with the start of decoding.

The viewer sensor 101 is made of a camera having an imaging element. The viewer sensor 101 is installed perpendicularly to an LCD display screen 202 of the display unit 108 formed on the front of a cabinet 201 of the display device 100.

The viewer situation deciding unit 102 decides whether a face can be detected to what extent, for example, the face cannot be detected, one-half of the face can be detected, three-fourths of the face can be detected or all of the face can be detected based on imaging data inputted from this camera. Then, the viewer situation deciding unit 102 periodically notifies the display rate determining unit 104 of a decision result of a face detection situation.

The display rate determining unit 104 determines a display rate based on the frame rate information (60 fps) notified from the decoding unit 103 and the decision result of the face detection situation periodically notified from the viewer situation deciding unit 102, and notifies the image processing unit 106, the frame interpolating unit 107 and the display unit 108 of this determined display rate.

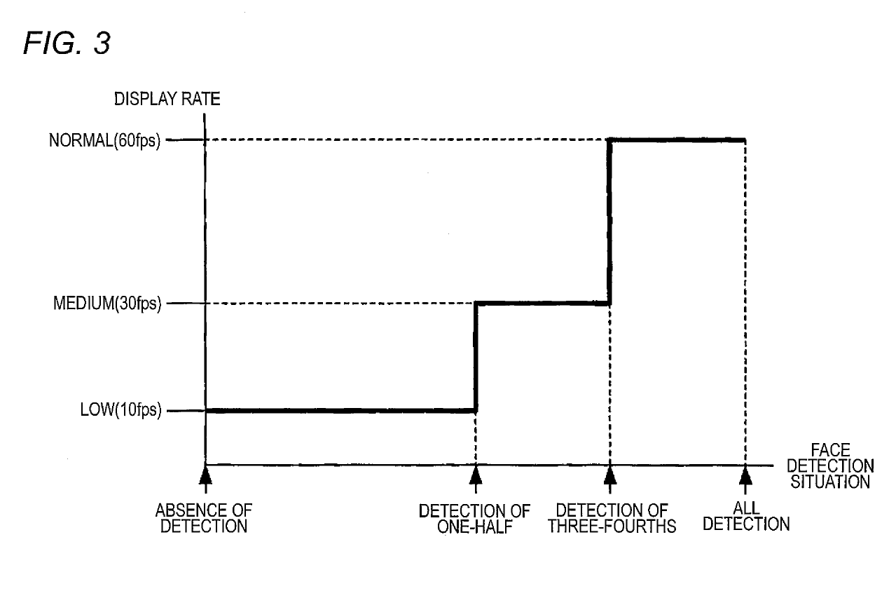

The display rate determining unit 104 determines whether, for example, the display rate is decreased by setting the display rate at a low rate (10 fps) or a medium rate (30 fps), or the display rate is kept the frame rate information (60 fps) notified from the decoding unit 103 based on the decision result of the face detection situation as shown in FIG. 3. FIG. 3 is a graph showing a change in the display rate corresponding to the face detection situation. In FIG. 3, the display rate is set at three stages based on the decision result of the face detection situation. That is, in the range from the absence of detection of a face to detection of one-half of the face, the display rate is set at a low rate (10 fps). Also, in the range from detection of one-half of the face to detection of three-fourths of the face, the display rate is set at a medium rate (30 fps). Further, in the range from detection of three-fourths of the face to detection of all of the face, the display rate is set at a normal rate (60 fps).

The display unit 108 reads image data out of the image memory 105 in one frame unit and displays the image data according to the display rate notified from the display rate determining unit 104.

The manipulating unit 109 is manipulated by a viewer, and notifies the display rate determining unit 104, the image processing unit 106 and the frame interpolating unit 107 of information about, for example, the presence or absence of processing. Also, the manipulating unit 109 has, for example, a touch panel stuck on the display unit 108, and manipulation instructions are inputted by a gesture expressed by a finger.

A viewer can set whether or not to respectively execute processing of the image processing unit 106 and processing of the frame interpolating unit 107. Only when the viewer sets execution of the processing, the image processing unit 106 and the frame interpolating unit 107 operate respectively and execute the processing.

When the viewer sets execution of the processing, the image processing unit 106 does not perform image processing with respect to all the image data present in the image memory 105, and reads image data out of the image memory 105 in one frame unit according to the display rate notified from the display rate determining unit 104 and executes image processing and thereafter, again writes and returns the image data to the image memory 105.

When the viewer sets execution of the processing, the frame interpolating unit 107 executes frame interpolation processing and writes and returns image data whose display rate is doubled (120 fps) to the image memory 105 only when the display rate notified from the display rate determining unit 104 is equal to the frame rate information (60 fps) notified from the decoding unit 103.

In the first embodiment, the display device 100 detects a face facing the LCD display screen 202 by the viewer sensor 101 and estimates whether or not a viewer can have gazed, and when the viewer has not gazed, a further saving in electric power can be achieved by decreasing the display rate.

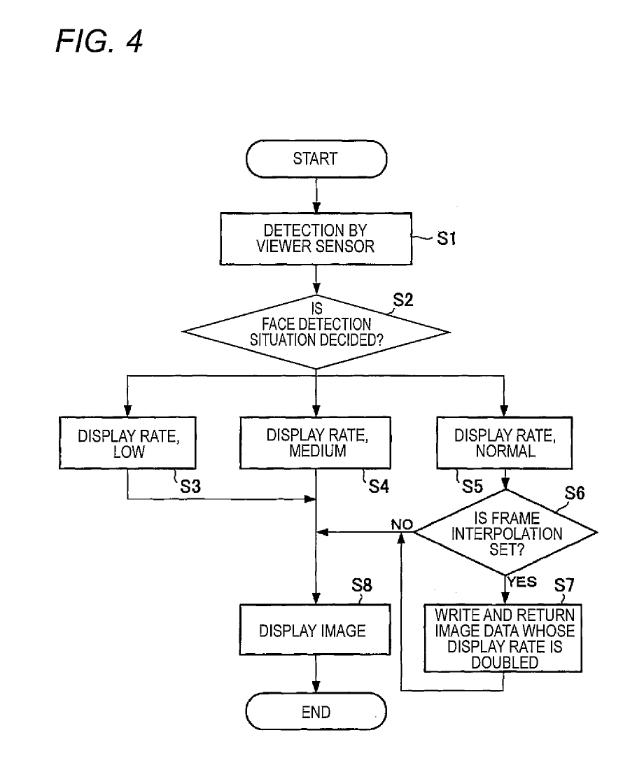

FIG. 4 is a flowchart showing a display operation procedure of the display device 100. In the display device 100, the following display operation is performed. The display device 100 detects a situation of a face facing the LCD display screen 202 by the viewer sensor 101 (step S1). Then, the display device 100 decides a face detection situation by the viewer situation deciding unit 102 (step S2). When the face detection situation is in the range from the absence of face detection, in which the face facing the LCD display screen 202 is not detected, to detection of one-half of the face, the display device 100 sets a display rate at a low rate (10 fps) by the display rate determining unit 104 (step S3). Then, the display device 100 reads out and displays image data stored in the image memory 105 at the display rate set at this “low” rate by the display unit 108 (step S8). Thereafter, the display device 100 ends the present operation.

Also, when the face detection situation decided in step S2 is in the range from detection of one-half of the face to detection of three-fourths of the face, the display device 100 sets the display rate at a medium rate (30 fps) by the display rate determining unit 104 (step S4). Then, the display device 100 reads out and displays image data stored in the image memory 105 at the display rate set at this “medium” rate by the display unit 108 in step S8. Thereafter, the display device 100 ends the present operation.

Also, when the face detection situation decided in step S2 is in the range from detection of three-fourths of the face to detection of all of the face, the display device 100 sets the display rate at a normal rate (60 fps) by the display rate determining unit 104 (step S5).

Then, the display device 100 determines whether or not execution of frame interpolation processing is set by viewer manipulation instructions through the manipulating unit 109 (step S6). When the execution of frame interpolation processing is set, the display device 100 reads image data out of the image memory 105 and executes frame interpolation processing and writes and returns image data whose display rate is doubled (120 fps) to the image memory 105 by the frame interpolating unit 107 (step S7). Then, the display device 100 reads and displays the image data whose display rate is doubled out of the image memory 105 at the display rate set at the “normal” rate by the display unit 108 in step S8. Thereafter, the display device 100 ends the present operation.

On the other hand, when the execution of frame interpolation processing is not set in step S6, the display device 100 reads out and displays image data stored in the image memory 105 at the display rate set at the “normal” rate by the display unit 108 in step S8. Thereafter, the display device 100 ends the present operation.

According to the display device of the first embodiment thus, by deciding a situation of a viewer using face detection, a display rate can be changed and a further saving in electric power can be achieved without giving a feeling of strangeness to the viewer. That is, it is estimated whether or not the viewer can have gazed by detecting a face facing the LCD display screen, and when the viewer has not gazed, the saving in electric power can efficiently be achieved by decreasing the display rate and the further saving in electric power can be achieved.

In addition, in the embodiment described above, the viewer situation deciding unit 102 simply detects a face, but may further detect facial expression after the face is detected as well as face detection. The art of detecting facial expression is well known already, and in the present embodiment, the viewer situation deciding unit 102 decreases the display rate using a decrease in recognition power of smoothness of a moving image, for example, when tears gather due to cries or when eyes become narrow due to laughs.

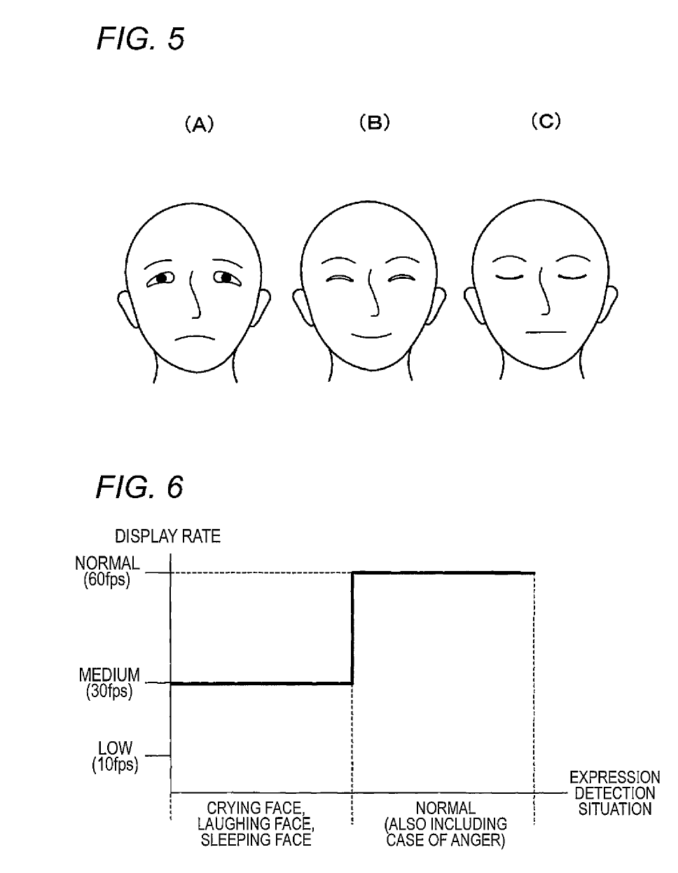

FIGS. 5(A) to 5(C) are diagrams showing facial expressions capable of being detected by the viewer situation deciding unit 102. FIG. 5(A) shows a crying face, and FIG. 5(B) shows a laughing face, and FIG. 5(C) shows a sleeping face. The viewer situation deciding unit 102 decides a detection situation of facial expressions such as a crying face, a laughing face or a sleeping face, and notifies the display rate determining unit 104 of this facial expression detection situation as a decision result. The display rate determining unit 104 changes a display rate based on the detection situation of the expression notified.

FIG. 6 is a graph showing a change in a display rate corresponding to a facial expression detection situation. In an example of FIG. 6, the display rate determining unit 104 sets the display rate at a medium rate (30 fps) lower than the normal case (also including the case of anger) in the case of a crying face, a laughing face or a sleeping face. The change in the display rate corresponding to the facial expression detection situation is not limited to the example of FIG. 6 naturally.

Thus, it is estimated whether or not a viewer can have gazed from the facial expression, and when it is estimated that the viewer has not gazed, a further saving in electric power can be achieved by decreasing the display rate.

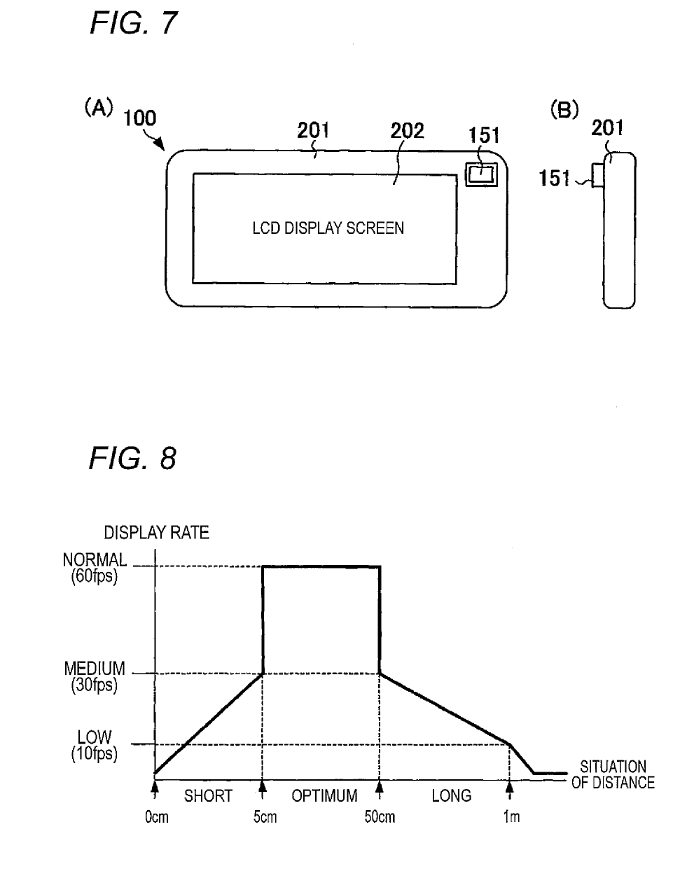

Also, in the embodiment described above, the camera is used in the viewer sensor, but the viewer sensor may be an infrared sensor (distance sensor) capable of detecting a distance to an object facing the front of the LCD display screen. FIGS. 7(A) and 7(B) are diagrams showing an external appearance of a display device provided with the infrared sensor as the viewer sensor, and FIG. 7(A) shows the front of the display device and FIG. 7(B) shows the side of the display device. A viewer sensor 151 is installed perpendicularly to the LCD display screen 202 attached to the cabinet 201 of the display device 100.

The viewer sensor 151 detects a distance to an object (including a viewer) as the infrared sensor, and notifies the viewer situation deciding unit 102. The viewer situation deciding unit 102 decides whether the distance detected by the infrared sensor is a too short distance, an optimum distance or a too long distance by a decision as to whether or not to be within a certain range, and periodically notifies the display rate determining unit 104 of a situation of the distance. The display rate determining unit 104 may determine a display rate based on that information.

FIG. 8 is a graph showing a change in a display rate corresponding to a situation of a distance. In an example of FIG. 8, the display rate determining unit 104 sets the display rate at a low rate when a distance to an object is short or long. Concretely, when the distance is in the range from 0 cm to 5 cm, the display rate is set at values increasing in proportion to the distance from a value of a low rate (10 fps) or less to a medium rate (30 fps). Also, when the distance is in the range from 5 cm to 50 cm, the display rate is fixed at a normal value (60 fps). Further, when the distance is in the range from 50 cm to 1 m, the display rate is set at values decreasing in proportion to the distance from the medium rate (30 fps) to the low rate (10 fps). When the distance is 1 m or more, the display rate is set at a lower value.

This setting is based on estimation that when the distance from the object (viewer) is not an optimum distance, recognition power of smoothness of a moving image decreases or the viewer cannot have gazed. Thus, it is estimated whether or not the viewer can have gazed, and when it is estimated that the viewer cannot have gazed, a further saving in electric power can be achieved by decreasing the display rate.

Also, the viewer sensor may be a combination (directional sensor) of a camera capable of detecting front and back directions and a gyro sensor capable of detecting left, right, upward and downward directions as an attitude of the display device. In this case, except when the display device is in the front direction and the upward direction, that is, when the directions other than the upward direction and the front direction are detected, setting can be made so as to decrease the display rate. Accordingly, it can be estimated whether or not a viewer can have gazed, and a further saving in electric power can be achieved.

Also, the viewer sensor may be a gyro sensor (motion sensor) capable of detecting motion of the display device, and may detect the strength of the motion. Here, when motion is strong and has a predetermined value or more, setting can be made so as to decrease the display rate. Accordingly, it can be estimated whether or not a viewer can have gazed, and a further saving in electric power can be achieved.

### Second Embodiment

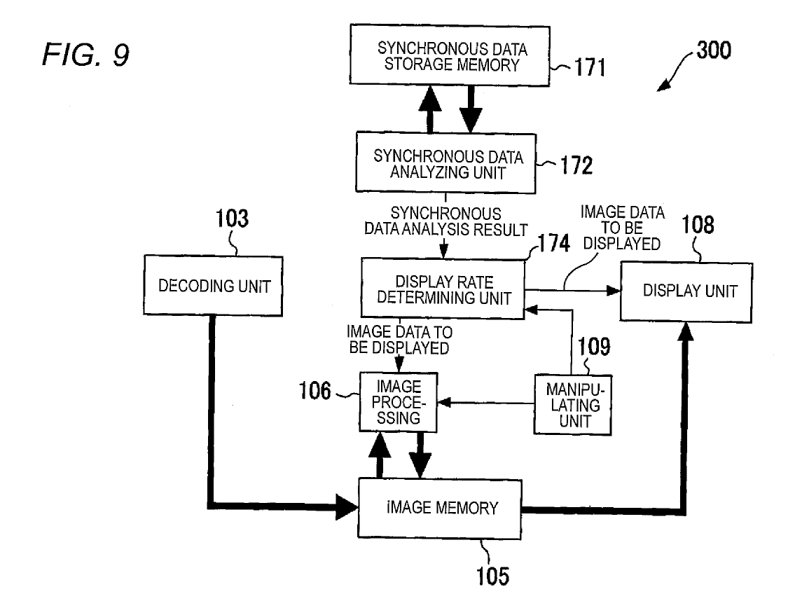

FIG. 9 is a diagram showing a configuration of a display device 300 of a second embodiment. The same components as those of the first embodiment are represented by the same numerals.

The display device 300 of the second embodiment has a decoding unit 103, a synchronous data storage memory 171, a synchronous data analyzing unit 172, a display rate determining unit 174, an image memory 105, an image processing unit 106, a display unit 108, and a manipulating unit 109.

The decoding unit 103 decodes (decodes), for example, moving image data of digital TV broadcasting. Also, the decoding unit 103 decodes the moving image data at a speed according to the moving image data, and stores this decoding result in the image memory 105 together with display time information.

The synchronous data storage memory 171 stores caption data in synchronization with image data stored in the image memory 105.

The synchronous data analyzing unit 172 analyzes the caption data stored in the synchronous data storage memory 171, and notifies the display rate determining unit 174 of ON timing and OFF timing of caption display as this synchronous data analysis result.

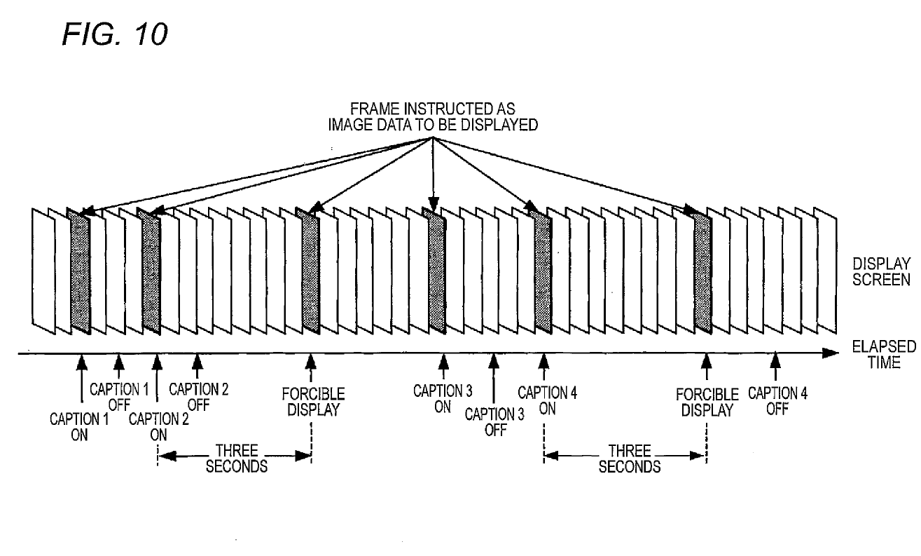

The display rate determining unit 174 determines image data with the same display time as the ON timing of caption display as shown in FIG. 10 based on the synchronous data analysis result which is ON/OFF timing of caption display notified from the synchronous data analyzing unit 172. FIG. 10 is a diagram showing frames instructed to display image data. Also, the display rate determining unit 174 determines image data to be displayed so as to update display forcibly when the image data is not updated for three seconds or more as shown in FIG. 10. Then, the display rate determining unit 174 notifies the image processing unit 106 and the display unit 108 of the determined image data to be displayed.

The display unit 108 reads the image data to be displayed notified from the display rate determining unit 174 out of the image memory 105 in one frame unit and displays the image data.

The manipulating unit 109 is manipulated by a viewer, and notifies the display rate determining unit 174 and the image processing unit 106 of information about, for example, the presence or absence of processing.

A viewer can set whether or not to execute processing of the image processing unit 106. Only when the viewer sets execution of the processing, the image processing unit 106 operates. When the viewer sets execution of the processing, the image processing unit 106 does not perform image processing with respect to all the image data present in the image memory 105, and reads the image data to be displayed notified from the display rate determining unit 174 out of the image memory 105 in one frame unit and executes image processing and thereafter, again writes and returns the image data to the image memory 105.

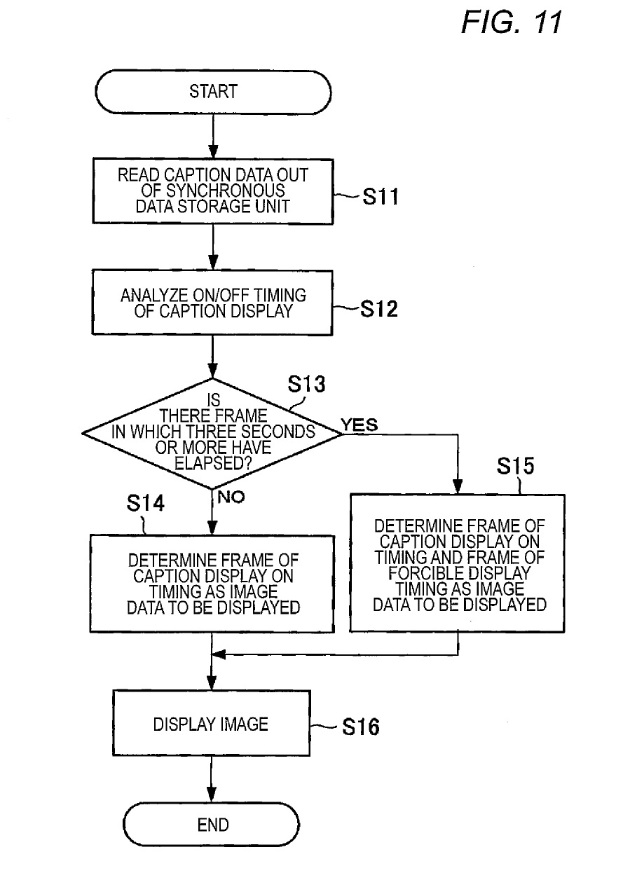

FIG. 11 is a flowchart showing a display operation procedure of the display device 300. The display device 300 reads out caption data stored in the synchronous data storage memory 171 (step S11), and analyzes ON/OFF timing of caption display by the synchronous data analyzing unit 172 (step S12).

The display device 300 determines whether or not there is a frame in which three seconds or more have elapsed at an interval between caption ON timings (update timings) by the display rate determining unit 174 (step S13). When there is no frame in which three seconds or more have elapsed, the display device 300 determines a frame of caption display ON timing as image data to be displayed by the display rate determining unit 174 (step S14). On the other hand, when there is a frame in which three seconds or more have elapsed, the display device 300 determines a frame of caption display ON timing and a frame to be displayed forcibly by a lapse of three seconds or more as image data to be displayed by the display rate determining unit 174 (step S15).

Then, the display device 300 reads the image data to be displayed out of the image memory 105 and displays the image data by the display unit 108 (step S16). Thereafter, the display device 300 ends the present operation.

According to the display device of the second embodiment thus, by updating display using the ON/OFF timing of caption display, a display rate can dramatically be decreased to the extent to which understanding of the contents of viewing is not missed, and a further saving in electric power can be achieved.

### Third Embodiment

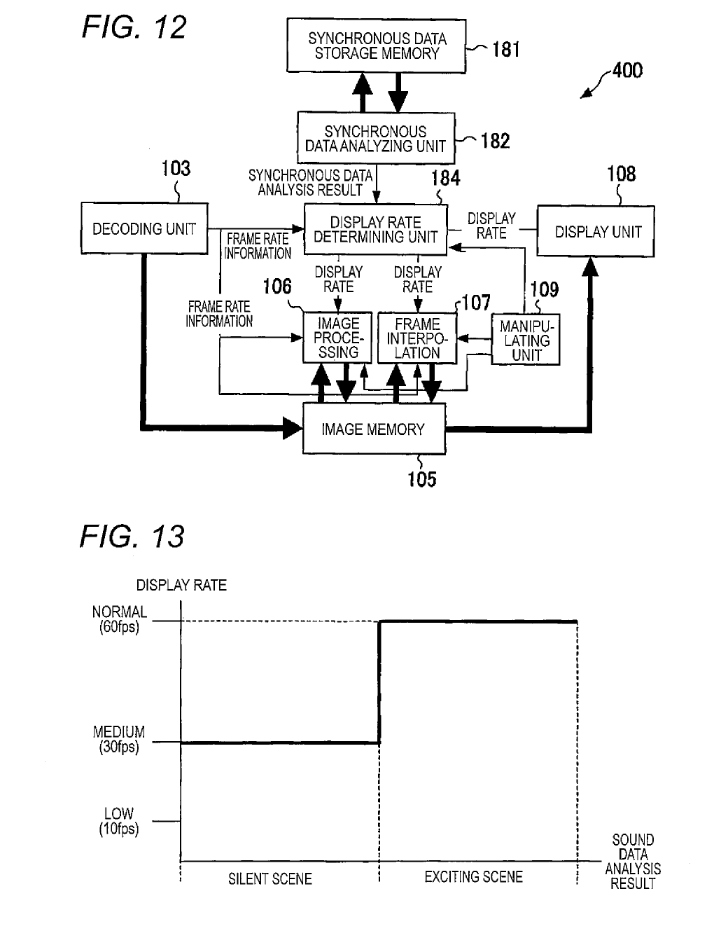

FIG. 12 is a diagram showing a configuration of a display device 400 of a third embodiment. The same components as those of the first and second embodiments are represented by the same numerals.

The display device 400 of the third embodiment has a decoding unit 103, a synchronous data storage memory 181, a synchronous data analyzing unit 182, a display rate determining unit 184, an image memory 105, an image processing unit 106, a display unit 108, and a manipulating unit 109.

The decoding unit 103 decodes (decodes), for example, moving image data of digital TV broadcasting. Also, the decoding unit 103 decodes the moving image data at a speed according to the moving image data, and stores this decoding result in the image memory 105. In the third embodiment, a decoding speed of the moving image data is 60 fps. The decoding unit 103 notifies the display rate determining unit 184, the image processing unit 106 and a frame interpolating unit 107 of frame rate information (60 fps) simultaneously with the start of decoding.

The synchronous data storage memory 181 stores sound data in synchronization with the moving image data stored in the image memory 105.

The synchronous data analyzing unit 182 analyzes the sound data stored in the synchronous data storage memory 181, and decides whether or not the moving image is an exciting scene, and periodically notifies the display rate determining unit 184 of this synchronous data analysis result. Here, the decision as to whether or not to be the exciting scene is made by detecting various pieces of information, for example, a sudden increase in sound volume or a big change in balance of a low-tone range and a high-tone range.

The display rate determining unit 184 determines a display rate based on the frame rate information (60 fps) notified from the decoding unit 103 and the synchronous data analysis result periodically notified from the synchronous data analyzing unit 182, and notifies the image processing unit 106, the frame interpolating unit 107 and the display unit 108 of this determined display rate.

The display rate determining unit 184 determines whether the display rate is decreased at a medium rate (30 fps) in the case of a silent scene, or the display rate is kept a normal rate (60 fps) which is the frame rate information notified from the decoding unit 103 in the case of an exciting scene as shown in FIG. 13. FIG. 13 is a graph showing a change in the display rate corresponding to a sound data analysis result. FIG. 13 shows that the display rate is a medium rate (30 fps) in the case of a silent scene and the display rate is a normal rate (60 fps) in the case of an exciting scene as a result of sound data analysis.

The display unit 108 reads image data out of the image memory 105 in one frame unit and displays the image data according to the display rate notified from the display rate determining unit 184.

A viewer can set whether or not to respectively execute processing of the image processing unit 106 and processing of the frame interpolating unit 107. Only when the viewer sets execution of the processing, the image processing unit 106 and the frame interpolating unit 107 operate.

When the viewer sets execution of the processing, the image processing unit 106 does not perform image processing with respect to all the image data present in the image memory 105, and reads image data out of the image memory 105 in one frame unit according to the display rate notified from the display rate determining unit 184 and executes image processing and thereafter, again writes and returns the image data to the image memory 105.

When the viewer sets execution of the processing, the frame interpolating unit 107 executes frame interpolation and writes and returns image data whose display rate is doubled (120 fps) to the image memory 105 only when the display rate notified from the display rate determining unit 184 is equal to the frame rate information (60 fps) notified from the decoding unit 103.

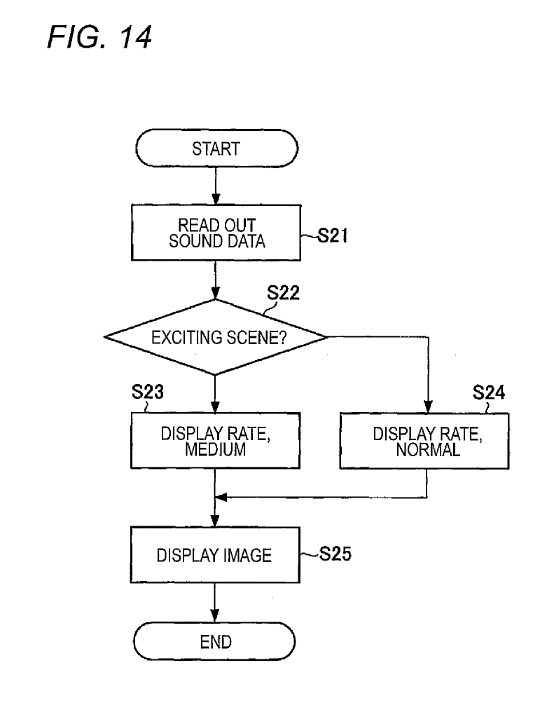

FIG. 14 is a flowchart showing a display operation procedure of the display device 400. The display device 400 reads sound data out of the synchronous data storage memory 181 (step S21). The display device 400 analyzes the read sound data by the synchronous data analyzing unit 182, and determines whether the sound data is a silent scene or an exciting scene (step S22).

In the case of the silent scene, the display device 400 sets a display rate at a medium rate (30 fps) by the display rate determining unit 184 (step S23). On the other hand, in the case of the exciting scene, the display device 400 sets the display rate at a normal rate (60 fps) by the display rate determining unit 184 (step S24).

After the processing of steps S23 and S24, the display device 400 reads the image data out of the image memory 105 and displays the image data by the display unit 108 (step S25). Thereafter, the display device 300 ends the present operation.

Thus, the display device of the third embodiment decides whether or not a moving image is an exciting scene from sound data and thereby, a display rate can be changed according to the contents of viewing, and a further saving in electric power can be achieved.

### Fourth Embodiment

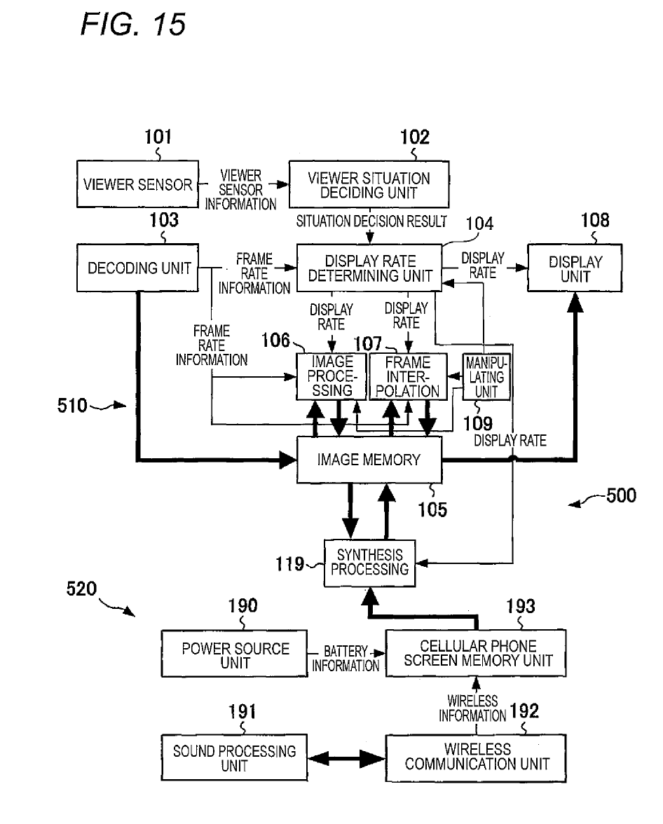

A display device of a fourth embodiment is mounted in a cellular phone which is a mobile portable terminal. FIG. 15 is a diagram showing a configuration of a cellular phone 500 in which the display device of the fourth embodiment is mounted.

The cellular phone 500 of the fourth embodiment includes a display unit 510 and a telephone call unit 520. The display unit 510 has a viewer sensor 101, a viewer situation deciding unit 102, a decoding unit 103, a display rate determining unit 104, an image memory 105, an image processing unit 106, a frame interpolating unit 107, a display unit 108, and a manipulating unit 109 like the first embodiment.

Also, the telephone call unit 520 has a synthesis processing unit 119, a power source unit 190, a sound processing unit 191, a wireless communication unit 192, and a cellular phone screen memory unit 193.

In the display unit 510, the decoding unit 103 decodes (decodes), for example, moving image data of digital TV broadcasting. The decoding unit 103 decodes (decodes) the moving image data at a speed according to the moving image data, and stores this decoding result in the image memory 105 as described below. Simultaneously with the start of this decoding, the display rate determining unit 104, the image processing unit 106 and the frame interpolating unit 107 are notified of frame rate information.

The viewer sensor 101 is made of a camera having an imaging element, and is installed perpendicularly to an LCD display screen of the display unit 108 of the cellular phone 500.

The viewer situation deciding unit 102 decides whether a face can be detected to what extent, that is, a face detection situation, for example, the face cannot be detected, one-half of the face can be detected, three-fourths of the face can be detected or all of the face can be detected based on imaging data inputted from this camera. The viewer situation deciding unit 102 periodically notifies the display rate determining unit 104 of a decision result of this face detection situation.

The display rate determining unit 104 determines a display rate based on the frame rate information notified from the decoding unit 103 and the decision result of the face detection situation periodically notified from the viewer situation deciding unit 102, and notifies the image processing unit 106, the frame interpolating unit 107, the display unit 108 and the synthesis processing unit 119 of this determined display rate.

The display unit 108 reads image data out of the image memory 105 in one frame unit and displays the image data according to the display rate notified from the display rate determining unit 104.

A viewer can set whether or not to respectively execute processing of the image processing unit 106 and processing of the frame interpolating unit 107. Only when the viewer sets execution of the processing, the image processing unit 106 and the frame interpolating unit 107 operate.

When the viewer sets execution of the processing, the image processing unit 106 does not perform image processing with respect to all the image data present in the image memory 105, and reads image data out of the image memory 105 in one frame unit according to the display rate notified from the display rate determining unit 104 and executes image processing and thereafter, again writes and returns the image data to the image memory 105.

When the viewer sets execution of the processing, the frame interpolating unit 107 executes frame interpolation and writes and returns image data whose display rate is doubled to the image memory 105 only when the display rate notified from the display rate determining unit 104 is equal to the frame rate information notified from the decoding unit 103.

In the telephone call unit 520, the power source unit 190 detects the amount of remaining battery of the cellular phone 500, and notifies the cellular phone screen memory unit 193 of the amount of remaining battery.

The sound processing unit 191 includes a microphone and a speaker, and decodes sound encoded data received from the wireless communication unit 192 at the time of a sound telephone call, and outputs the data from the speaker, and encodes sound data inputted from the microphone, and sends the sound data to the wireless communication unit 192. Also, at the time of moving image reproduction or digital TV viewing, the sound processing unit 191 decodes sound data in synchronization with a moving image, and sounds the sound data from the speaker.

The wireless communication unit 192 executes processing of encryption etc. with respect to sound encoded data received from the sound processing unit 191 and sends the data to a base station, and also executes processing of decryption etc. with respect to data received from the base station and sends sound encoded data to the sound processing unit 191. Also, the wireless communication unit 192 notifies the cellular phone screen memory unit 193 of the strength of a radio reception state.

The cellular phone screen memory unit 193 generates a display screen in which a user of the cellular phone can understand the amount of remaining battery and the strength of the radio reception state notified, and the display screen is stored in an internal memory of the cellular phone screen memory unit 193.

The synthesis processing unit 119 synthesizes the display screen stored in the cellular phone screen memory unit 193 and image data stored in the image memory 105 according to the display rate notified, and again writes and returns the display screen and the image data to the image memory 105.

In addition, display operation of the cellular phone 500 is substantially similar to the operation shown in FIG. 4 in the first embodiment. In the fourth embodiment, when an image is displayed in step S8 of FIG. 4, the display screen stored in the cellular phone screen memory unit 193 and the image data stored in the image memory 105 are synthesized and displayed.

In the cellular phone of the fourth embodiment thus, like the first embodiment, it is estimated whether or not a viewer can have gazed by detecting a face facing the LCD display screen of the cellular phone, and when the viewer has not gazed, a further saving in electric power can be achieved by decreasing the display rate.

### Fifth Embodiment

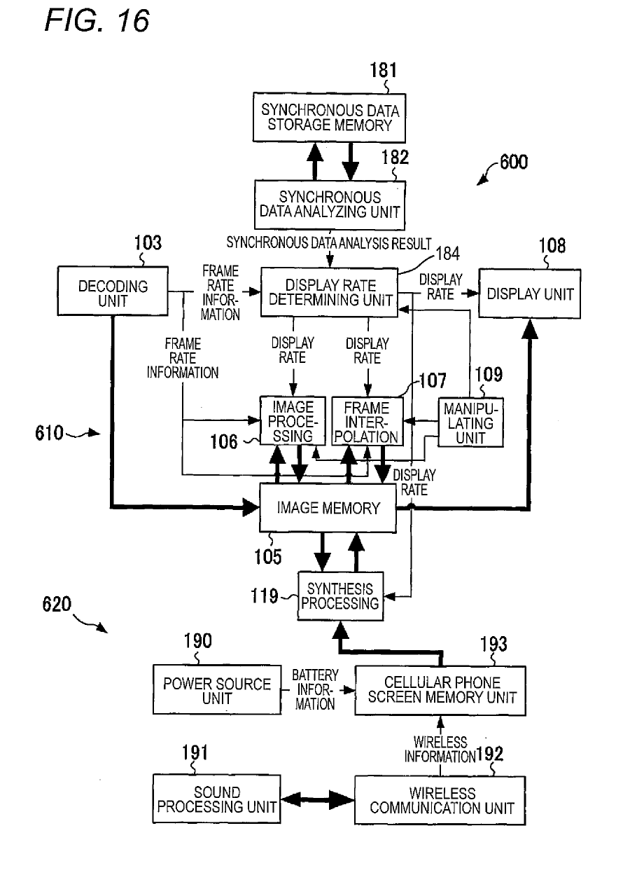

A display device of a fifth embodiment is mounted in a cellular phone which is a mobile portable terminal. FIG. 16 is a diagram showing a configuration of a cellular phone 600 in which the display device of the fifth embodiment is mounted.

The cellular phone 600 of the fifth embodiment includes a display unit 610 and a telephone call unit 620. The same components as those of the third and fourth embodiments are represented by the same numerals.

The display unit 610 has a decoding unit 103, a synchronous data storage memory 181, a synchronous data analyzing unit 182, a display rate determining unit 184, an image memory 105, an image processing unit 106, a frame interpolating unit 107, a display unit 108, and a manipulating unit 109. Also, the telephone call unit 620 has a synthesis processing unit 119, a power source unit 190, a sound processing unit 191, a wireless communication unit 192, and a cellular phone screen memory unit 193.

In the display unit 610, the decoding unit 103 decodes (decodes), for example, moving image data of digital TV broadcasting. Also, the decoding unit 103 decodes the moving image data at a speed according to the moving image data, and stores this decoding result in the image memory 105. The decoding unit 103 notifies the display rate determining unit 184, the image processing unit 106 and the frame interpolating unit 107 of frame rate information (60 fps) simultaneously with the start of decoding.

The synchronous data storage memory 181 stores sound data in synchronization with the moving image data stored in the image memory 105. Also, the synchronous data analyzing unit 182 analyzes the sound data stored in the synchronous data storage memory 181, and decides whether or not the moving image is an exciting scene, and periodically notifies the display rate determining unit 184 of this synchronous data analysis result.

The display rate determining unit 184 determines a display rate based on the frame rate information notified from the decoding unit 103 and the synchronous data analysis result periodically notified from the synchronous data analyzing unit 182, and notifies the image processing unit 106, the frame interpolating unit 107 and the display unit 108 of this determined display rate.

The display rate determining unit 184 determines whether the display rate is decreased at a medium rate (30 fps) in the case of a silent scene, or the display rate is kept a normal rate (60 fps) which is the frame rate information notified from the decoding unit 103 in the case of an exciting scene as shown in FIG. 13 of the third embodiment.

The display unit 108 reads image data out of the image memory 105 in one frame unit and displays the image data according to the display rate notified from the display rate determining unit 184.

A viewer can set whether or not to respectively execute processing of the image processing unit 106 and processing of the frame interpolating unit 107. Only when the viewer sets execution of the processing, the image processing unit 106 and the frame interpolating unit 107 operate.

When the viewer sets execution of the processing, the image processing unit 106 does not perform image processing with respect to all the image data present in the image memory 105, and reads image data out of the image memory 105 in one frame unit according to the display rate notified from the display rate determining unit 184 and executes image processing and thereafter, again writes and returns the image data to the image memory 105.

When the viewer sets execution of the processing, the frame interpolating unit 107 executes frame interpolation and writes and returns image data whose display rate is doubled (120 fps) to the image memory 105 only when the display rate notified from the display rate determining unit 184 is equal to the frame rate information (60 fps) notified from the decoding unit 103.

In the telephone call unit 620, the power source unit 190 detects the amount of remaining battery of the cellular phone 600, and notifies the cellular phone screen memory unit 193 of the amount of remaining battery.

The sound processing unit 191 includes a microphone and a speaker, and decodes sound encoded data received from the wireless communication unit 192 at the time of a sound telephone call, and outputs the data from the speaker, and encodes sound data inputted from the microphone, and sends the sound data to the wireless communication unit 192. Also, at the time of moving image reproduction or digital TV viewing, the sound processing unit 191 decodes sound data in synchronization with a moving image, and sounds the sound data from the speaker.

The wireless communication unit 192 executes processing of encryption etc. with respect to sound encoded data received from the sound processing unit 191 and sends the data to a base station, and also executes processing of decryption etc. with respect to data received from the base station and sends sound encoded data to the sound processing unit 191. Also, the wireless communication unit 192 notifies the cellular phone screen memory unit 193 of the strength of a radio reception state.

The cellular phone screen memory unit 193 generates a display screen in which a user of the cellular phone can understand the amount of remaining battery and the strength of the radio reception state notified, and the display screen is stored in an internal memory of the cellular phone screen memory unit 193.

The synthesis processing unit 119 synthesizes the display screen stored in the cellular phone screen memory unit 193 and image data stored in the image memory 105 according to the display rate notified, and again writes and returns the display screen and the image data to the image memory 105.

In addition, display operation of the cellular phone 600 is substantially similar to the operation shown in FIG. 14 in the third embodiment. In the fifth embodiment, when an image is displayed in step S25 of FIG. 14, the display screen stored in the cellular phone screen memory unit 193 and the image data stored in the image memory 105 are synthesized and displayed.

In the cellular phone of the fifth embodiment thus, it is decided whether or not a moving image is an exciting scene from sound data and thereby, a display rate can be changed according to the contents of viewing, and a further saving in electric power can be achieved.

### Sixth Embodiment

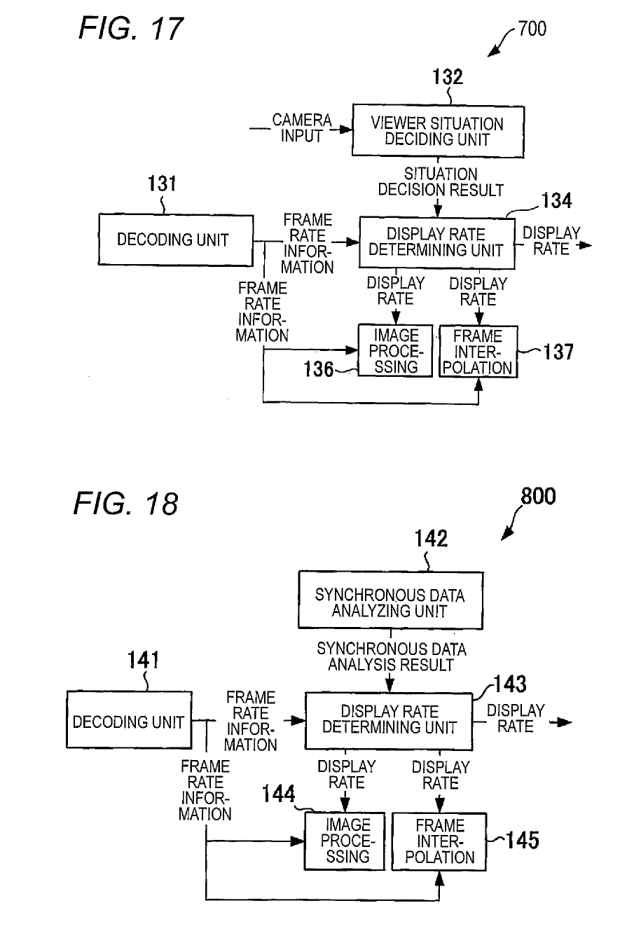

A function of a main unit of the display device of the first embodiment can also be implemented as a semiconductor chip (semiconductor device). FIG. 17 is a diagram showing a configuration of a semiconductor chip 700 of a sixth embodiment. The semiconductor chip 700 is equipped with a decoding unit 131, a viewer situation deciding unit 132, a display rate determining unit 134, an image processing unit 136, and a frame interpolating unit 137.

Functions of the decoding unit 131, the viewer situation deciding unit 132, the display rate determining unit 134, the image processing unit 136 and the frame interpolating unit 137 are respectively similar to functions of the decoding unit 103, the viewer situation deciding unit 102, the display rate determining unit 104, the image processing unit 106 and the frame interpolating unit 107 of the first embodiment.

That is, the decoding unit 131 decodes (decodes), for example, moving image data of digital TV broadcasting. The decoding unit 103 notifies the display rate determining unit 134, the image processing unit 136 and the frame interpolating unit 137 of frame rate information simultaneously with the start of this decoding.

The viewer situation deciding unit 132 decides whether a face can be detected to what extent, that is, a face detection situation, for example, the face cannot be detected, one-half of the face can be detected, three-fourths of the face can be detected or all of the face can be detected based on imaging data inputted from a camera. The viewer situation deciding unit 132 periodically notifies the display rate determining unit 134 of a decision result of this face detection situation.

The display rate determining unit 134 determines a display rate based on the frame rate information notified from the decoding unit 131 and the decision result of the face detection situation periodically notified from the viewer situation deciding unit 132, and notifies the image processing unit 136 and the frame interpolating unit 137 of this determined display rate.

The image processing unit 136 does not perform image processing with respect to all the image data, and executes image processing according to the display rate notified from the display rate determining unit 134.

The frame interpolating unit 137 executes frame interpolation and generates image data whose display rate is doubled only when the display rate notified from the display rate determining unit 134 is equal to the frame rate information notified from the decoding unit 131.

By mounting the semiconductor chip of the sixth embodiment in electronic equipment such as a display device thus, it is estimated whether or not a viewer can have gazed by detecting a face, and the display rate can be decreased and a further saving in electric power can be achieved.

### Seventh Embodiment

A function of a main unit of the display device of the third embodiment can also be implemented as a semiconductor chip. FIG. 18 is a diagram showing a configuration of a semiconductor chip 800 of a seventh embodiment. The semiconductor chip 800 is equipped with a decoding unit 141, a synchronous data analyzing unit 142, a display rate determining unit 143, an image processing unit 144, and a frame interpolating unit 145.

Functions of the decoding unit 141, the synchronous data analyzing unit 142, the display rate determining unit 143, the image processing unit 144 and the frame interpolating unit 145 are respectively similar to functions of the decoding unit 103, the synchronous data analyzing unit 182, the display rate determining unit 184, the image processing unit 106 and the frame interpolating unit 107 of the third embodiment.

That is, the decoding unit 141 decodes (decodes), for example, moving image data of digital TV broadcasting. Also, the decoding unit 141 decodes the moving image data at a speed according to the moving image data. The decoding unit 141 notifies the display rate determining unit 143, the image processing unit 144 and the frame interpolating unit 145 of frame rate information (60 fps) simultaneously with the start of decoding.

The synchronous data analyzing unit 142 analyzes sound data, and decides whether or not to be an exciting scene, and periodically notifies the display rate determining unit 143 of this synchronous data analysis result.

The display rate determining unit 143 determines a display rate based on the frame rate information notified from the decoding unit 141 and the synchronous data analysis result periodically notified from the synchronous data analyzing unit 142, and notifies the image processing unit 144 and the frame interpolating unit 145 of this determined display rate.

The image processing unit 144 does not perform image processing with respect to all the image data, and executes image processing according to the display rate notified from the display rate determining unit 143.

The frame interpolating unit 145 executes frame interpolation and generates image data whose display rate is doubled only when the display rate notified from the display rate determining unit 143 is equal to the frame rate information notified from the decoding unit 141.

By mounting the semiconductor chip of the seventh embodiment in electronic equipment such as a display device thus, it is decided whether or not a moving image is an exciting scene from sound data, and the display rate can be changed according to the contents of viewing, and a further saving in electric power can be achieved.

In addition, the present invention is not limited to the configurations of the embodiments described above, and any configurations can be applied as long as the present invention has configurations capable of achieving a function shown in the claims or a function had by the configurations of the present embodiments.

For example, a face detection situation of a viewer may be combined with an analysis result of caption data or sound data to change a display rate. As one example, when the sound data is an exciting scene in a situation in which three-fourths or more of the face is detected, the display rate may be set at a display rate close to a normal rate and otherwise, the display rate may be decreased.

Thus, the present invention can achieve a further saving in electric power by decreasing a display rate in a situation in which power consumption necessary for display processing already occupies one-half or more of the power consumption of a recent portable terminal and display resolution of the portable terminal is further increasing in future, and the present invention is useful.

The present invention has been described in detail with reference to the specific embodiments, but it is apparent to those skilled in the art that various changes or modifications can be made without departing from the spirit and scope of the present invention.

The present application is based on Japanese patent application (patent application No. 2010-257196) filed on Nov. 17, 2010, and the contents of the patent application are hereby incorporated by reference.

A display device according to the present invention is useful as, for example, a display device for changing a display rate and displaying an image.

What is claimed is:

1. A display device for displaying an image, comprising:
an image storage unit configured to store an image signal inputted at a predetermined frame rate,
a detecting unit configured to detect data used in a case of deciding a situation of a viewer,
a viewer situation deciding unit configured to decide the situation of the viewer from the data detected by the detecting unit,
a display rate determining unit configured to determine a display rate based on the situation of the viewer decided by the viewer situation deciding unit and the predetermined frame rate at which the image signal is inputted, and
a display unit configured to read out image data stored in the image storage unit and displaying an image at the display rate determined by the display rate determining unit;
wherein the detecting unit includes a sensor detecting a state of the display device; and
the sensor includes a directional sensor detecting left, right, upward and downward directions and front and back directions as an attitude of the display device.

2. The display device as claimed in claim 1, wherein the viewer situation deciding unit decides whether or not an upward direction and a front direction are detected by the directional sensor.

3. The display device as claimed in claim 2, wherein the display rate determining unit determines the display rate so as to become lower than the predetermined frame rate when the viewer situation deciding unit decides that directions other than an upward direction and a front direction are detected.

4. The display device as claimed in claim 1, wherein the sensor includes a motion sensor detecting motion of the display device.

5. The display device as claimed in claim 4, wherein the viewer situation deciding unit decides whether or not motion of the display device is a predetermined value or more by the motion sensor.

6. The display device as claimed in claim 5, wherein the display rate determining unit determines the display rate so as to become lower than the predetermined frame rate when the viewer situation deciding unit decides that motion of the display device is a predetermined value or more.

7. A display device for displaying an image, comprising:
an image storage unit configured to store an image signal inputted at a predetermined frame rate;
a synchronous data storage unit configured to store data in synchronization with the image signal;
a data analyzing unit configured to analyze the data stored in the synchronous data storage unit;
a display rate determining unit configured to determine a display rate based on an analysis result of the data by the data analyzing unit and the predetermined frame rate at which the image signal is inputted, and
a display unit configured to read out image data stored in the image storage unit and displaying an image at the display rate determined by the display rate determining unit.

8. The display device as claimed in claim 7, wherein data stored in the synchronous data storage unit includes caption data.

9. The display device as claimed in claim 8, wherein the data analyzing unit analyzes update timing of caption data stored in the synchronous data storage unit.

10. The display device as claimed in claim 7, wherein the display rate determining unit determines a display rate according to update timing of caption data analyzed by the data analyzing unit.

11. The display device as claimed in claim 7, wherein data stored in the synchronous data storage unit includes sound data.

12. The display device as claimed in claim 11, wherein the data analyzing unit decides an exciting scene from sound data stored in the synchronous data storage unit.

13. The display device as claimed in claim 12, wherein the display rate determining unit determines the display rate so as to become lower than the predetermined frame rate when the data analyzing unit does not decide that it is an exciting scene.

14. The display device as in claim 7, comprising an image processing unit configured to perform image processing with respect to image data displayed at a display rate determined by the display rate determining unit.

15. The display device as in claim 7, comprising a frame interpolating unit configured to execute frame interpolation with respect to image data displayed at a display rate determined by the display rate determining unit.

16. A display control method of a display device which comprises an image storage unit configured to store an image signal inputted at a predetermined frame rate and displays an image based on the image signal stored in the image storage unit, the display control method comprising:
a data analyzing step of analyzing data stored in a synchronous data storage unit,
a display rate determining step of determining a display rate based on an analysis result of the data in the data analyzing step and the predetermined frame rate at which the image signal is inputted, and
a display step of reading out image data stored in the image storage unit and displaying an image at the display rate determined in the display rate determining step.

17. A semiconductor device mounted in a display device, comprising:
a data analyzing unit configured to analyze data in synchronization with an image signal, and
a display rate determining unit configured to determine a display rate in the case of displaying an image based on the image signal based on an analysis result of the data by the data analyzing unit and a predetermined frame rate at which the image signal is inputted.
